(19) United States
(12) Patent Application Publication
(10) Pub. No.: US 2015/0332859 A1
(43) Pub. Date: Nov. 19, 2015

(54) Electrode, Device Including Same And Manufacturing Method Thereof

(71) Applicants: Commissariat A L'Énergie Atomique Et Aux Energies Alternatives, Paris (FR); University Joseph Fourier, Grenoble (FR)

(72) Inventors: Pascal Gentile, Voiron (FR); Saïd Sadki, Saint Martin D'Heres (FR); Fleur Thissandier, Bouquetot (FR); Emmanuel Hadji, Fontaine (FR)

(21) Appl. No.: 14/396,523

(22) PCT Filed: Apr. 22, 2013
(86) PCT No.: PCT/IB2013/053164

§ 371 Date: Oct. 23, 2014

(30) Foreign Application Priority Data
Apr. 23, 2012 (FR) 12 53690

(51) Int. Cl. H01G 11/04; H01G 11/86; H01G 11/48

(52) U.S. Cl. CPC H01G 11/04; H01G 11/48; H01G 11/86

(57) ABSTRACT

The invention relates to an electrode, to the method for manufacturing same and to a device for storing and delivering electric power including same. The electrode of the invention includes a mounting, made of a conductor or semiconductor material, the mounting including, on at least one of the surfaces thereof, at least one nanostructure made of a semiconductor material, characterized by also including a protective layer made of a material selected among a dielectric material having an intrinsic capacity of 1.5 10⁻⁶ to 10 10⁻⁶ F/cm² and a metal, the layer having a thickness that is less than the height of said nanostructure, and covering the at least one nanostructure. The invention is useful in the field of electrochemical storage and, in particular, in the field of ultracapacitors.

The invention relates to an electrode, to a device for storing and releasing electrical energy comprising same, and to a process for fabricating this electrode.

Electrodes are very widely used in many fields, and, in particular, in devices for storing and releasing electrical energy.

Among these devices for storing and releasing electrical energy, supercapacitors are increasingly being studied.

In a supercapacitor, the key point is the developed surface area of the electrodes.

There are a number of different types of supercapacitor.

The first type consists of supercapacitors that store energy in electrochemical double layers (EDLCs). These electrical energy storage devices store and liberate energy by virtue of the separation of ionic charges at the interface between an electrode and an electrolyte.

As the energy stored is inversely proportional to the thickness of the double layer, these supercapacitors have a very high energy density relative to conventional dielectric capacitors.

They are capable of storing a large amount of charge that may be delivered at much higher powers than rechargeable batteries.

Pseudo-capacitive supercapacitors represent a second type of supercapacitor.

The materials used in these supercapacitors allow fast faradaic reactions to take place at the electrode/electrolyte interface.

There are two main categories of pseudo-capacitive supercapacitors: supercapacitors based on metal oxides and supercapacitors based on intrinsically conductive polymers.

The electrochemical capacitance is due to reversible oxidation-reduction reactions that take place on the surface of the material of the electrodes in the presence of the electrolyte when a voltage is applied.

These materials must therefore be able to undergo rapid oxidation-reduction reactions involving a maximum number of degrees of oxidation in a window of potentials compatible with the electrochemical stability of the electrolyte used.

Thus, supercapacitors based on metal oxides represent a third type of supercapacitor.

In these supercapacitors, the electrochemical capacitance is due to oxidation-reduction reactions on the surface and in the volume of the material of the electrode.

This capacitance depends on the amount of charge transferred, which itself depends on the applied voltage.

Oxides of transition metals possess many oxidation states.

They may be prepared with a large specific surface area and certain oxides are electronically conductive.

Supercapacitors based on electronically conductive polymers represent a fourth type of supercapacitor.

Intrinsically electronically conductive polymers may receive electrons by electrochemical reduction (negative doping; n-type doping) or donate electrons by oxidation (positive doping; p-type doping).

The doping/dedoping is electrochemically reversible and intrinsically electronically conductive polymers may be used to store and release charge in supercapacitor and battery applications.

Electrically conductive polymers possess high electrochemical capacitances because the doping/dedoping process involves all the mass and volume of the polymer.

In the charged state, they possess high electron conductivities. The doping/dedoping process is rapid and the resistances obtained are low. They possess high power and energy densities—4000 W·kg⁻¹ and 10 Wh·kg⁻¹, respectively, for poly(3-methylthiophene).

Very recently, in the field of renewable energy, silicon nanowires have been studied for use in supercapacitors.

Silicon nanowires were first observed in 1964.

They demonstrated that it was possible to grow silicon wires with a diameter smaller than 1 μm.

They were developed by catalyzing the decomposition of a gaseous silicon precursor on metal impurities, thereby localizing the growth of the wires in the location of metal seeds.

During the years 1964-1965, the basic principles of the catalyzed “whisker” growth mechanism, referred to as the “vapor-liquid-solid” (VLS) mechanism, were established.

About thirty years later, growth of silicon wires from silane (SiH₄) with diameters of about 10 nm was demonstrated.

The term “nanowires” was then used to describe this new type of nanostructure.

VLS growth of nanowires has received much interest due to the potential applications of this new type of material in nanoelectronics, NEMS, sensors, photovoltaics and biosensors.

Using this VLS method, it is possible to produce more complex 3D structures: cones and trees.

These “branched” nanostructures consist of a trunk of silicon (the nanowire itself) from which substructures are grown (the branches).

At the present time, silicon nanotrees represent a unique way of radically improving the performance of micro-supercapacitors, because of their specific architectures and their extremely large developed surface area.

Thus, it is known to use silicon nanowires to increase the effective surface areas of the electrodes of supercapacitors, but also of any electrochemical device, and in particular those used to store and release electrical energy.

These electrodes have a large active surface area but in contrast their supercapacitance is not stable over time: it degrades very rapidly, especially at the start of their lifetime.

Thus, the aim of the invention is to obtain electrodes with very large active surface areas the supercapacitance of which is stable over time.

For this purpose, the invention proposes to create a controlled interface between the silicon or the other conductor or semiconductor forming the electrode, and the electrolyte.

For this purpose, the invention provides an electrode comprising a carrier, made of a conductor or semiconductor, this carrier comprising, on at least one of its surfaces, at least one nanostructure made of a semiconductor, characterized in that it in addition comprises a protective layer made of a material chosen from a dielectric having an intrinsic capacitance comprised between 1.5×10⁻⁶ and 10×10⁻⁶ F/cm² and a metal, this layer having a thickness smaller than the height of said nanostructure, and covering the at least one nanostructure.

The “intrinsic capacitance” of a material is understood to mean the capacitance of this material alone (for example in the absence of electrolyte for an electrode).

Preferably, the carrier is made of a conductor or semiconductor chosen from stainless steel, carbon, silicon, germanium, gallium arsenide (GaAs), alloys of silicon and germanium in any proportions (SiGe) and indium phosphide (InP).

More preferably, the carrier is made of silicon.

Preferably, the nanostructure is made of a semiconductor chosen from silicon, germanium, gallium arsenide, alloys of silicon and germanium in any proportions and indium phosphide.

More preferably, the nanostructure is made of silicon.

When the protective layer is made of a dielectric, this dielectric is preferably chosen from SiO₂, hafnium silicate, zirconium silicate, hafnium dioxide, zirconium dioxide, silicon nitride, ruthenium dioxide (RuO₂), manganese dioxide (MnO₂), vanadium oxide (V₂O₅) and iron oxide (Fe₃O₄).

Preferably, in particular when the nanostructure is made of silicon, the dielectric is made of SiO₂.

When the protective layer is made of metal, this metal is preferably chosen from gold (Au), platinum (Pt), silver (Ag), nickel (Ni) and titanium (Ti) and the thickness of this layer is comprised between 2 and 20 nm inclusive, preferably between inclusive and more preferably between 3 and 8 nm.

In a preferred embodiment, the electrode according to the invention in addition comprises a layer made of an intrinsically conductive polymer, on the protective layer made of a dielectric or of metal, this layer made of an intrinsically conductive polymer and the protective layer made of a dielectric or of metal having a total thickness smaller than the height of the nanostructure, preferably comprised between 2 and 20 nm, more preferably comprised between 3 and 20 nm and even more preferably comprised between 3 and 8 nm.

Preferably, the intrinsically conductive polymer is chosen from poly(3,4-ethylenedioxythiophene)s, poly(2,7-carbazole)s, poly(3,6-carbazole)s, polyanilines and polypyrroles.

More preferably, the intrinsically conductive polymer is poly(3,4-ethylenedioxythiophene).

The invention also provides a device for storing and releasing electrical energy, characterized in that it comprises at least one electrode according to the invention.

In a first preferred embodiment, the device according to the invention comprises at least two identical electrodes according to the invention.

In a second preferred embodiment, the device according to the invention comprises at least two electrodes one of which is an electrode according to the invention and the other of which is made of carbon, preferably with a large specific surface area (>1500 m²/g).

The invention also provides a process for fabricating an electrode comprising a carrier made of a conductor or semiconductor, this carrier comprising, on at least one of its surfaces, at least one nanostructure made of a semiconductor, characterized in that it comprises a step of forming, on said nanostructure, a protective layer made of a material chosen from a dielectric having a capacitance comprised between 1.5×10⁻⁶ and 10×10⁻⁶ F/cm² and a metal, this layer having a thickness smaller than the height of said nanostructure.

Preferably, the nanostructure is obtained by chemical vapor deposition (CVD) of the semiconductor on said surface of the carrier.

Also preferably, the protective layer is deposited by chemical or thermal oxidation of the material forming the nanostructure.

This protective layer may also be obtained by nitriding the material forming said nanostructure.

In one preferred embodiment, the process of the invention in addition comprises a step of depositing a layer made of a conductive polymer, on the protective layer made of a dielectric or of metal, this layer made of an intrinsically conductive polymer and the layer made of a dielectric or of metal having a total thickness smaller than the height of the nanostructure.

More preferably, the intrinsically conductive polymer is poly(3,4-ethylenedioxythiophene).

The invention will be better understood and other features and advantages thereof will become more clearly apparent on reading the following explanatory description that is given with reference to the figures, in which:

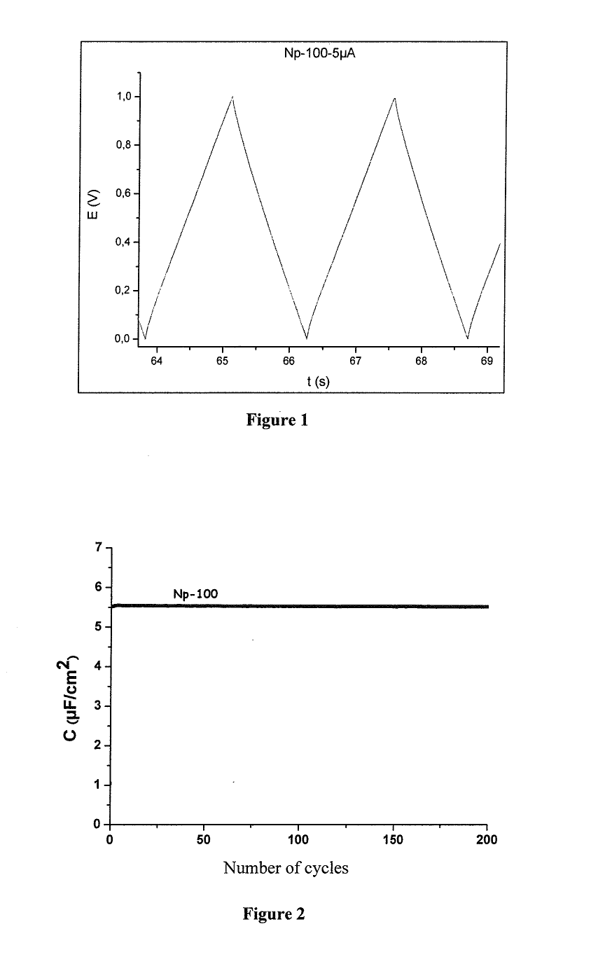

FIG. 1 shows the variation of the voltage as a function of time in galvanostatic charge/discharge cycles of a device composed of two electrodes according to the invention comprising nanostructures made of oxidized silicon. The working electrode is made of oxidized n⁺⁺ silicon and the counter electrode of oxidized p⁺⁺ silicon, and the electrolyte is NEt₄BF₄, PC, 1M;

FIG. 2 shows the variation of the capacitance per unit area of a device containing two electrodes comprising oxidized silicon nanostructures (curve referenced Np-100) and the electrolyte is NEt₄BF₄, PC, 1M, as a function of the number of galvanostatic charge/discharge cycles, the cycling being carried out at plus or minus 5 μA·cm² between 0.01 V and 1 V;

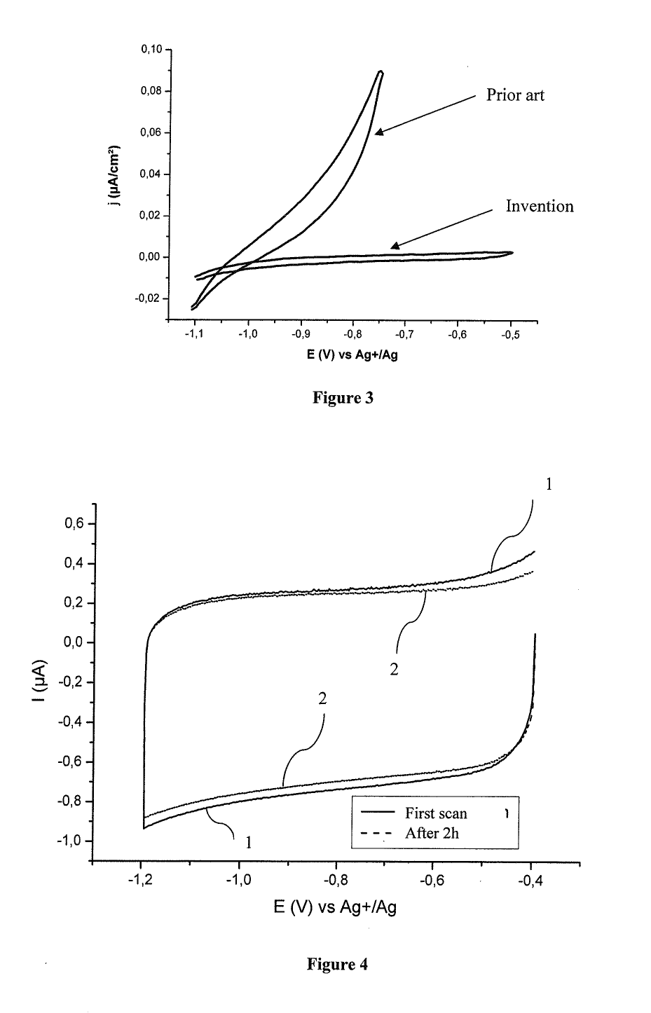

FIG. 3 shows, on the one hand, the cyclic voltammetry curve at 2 mV·s⁻¹ of a nanostructured p⁺⁺-doped silicon sample (curve referenced prior art) and, on the other hand, that of an oxidized nanostructured p⁺⁺-doped silicon sample (curve referenced invention), these curves being obtained in a free bath using an electrolyte that is 1-ethyl-3-methylimidazolium bis(trifluoromethylsulfonyl)imide (EMI-TFSI) (ionic liquid);

FIG. 4 shows the variation over time of the cyclic voltammetry curves at 20 mV·s⁻¹ of an electrode according to the invention comprising nanostructures made of oxidized n⁺⁺ silicon, and the electrolyte is 1-ethyl-3-methylimidazolium bis(trifluoromethylsulfonyl)imide (EMI-TFSI) (ionic liquid);

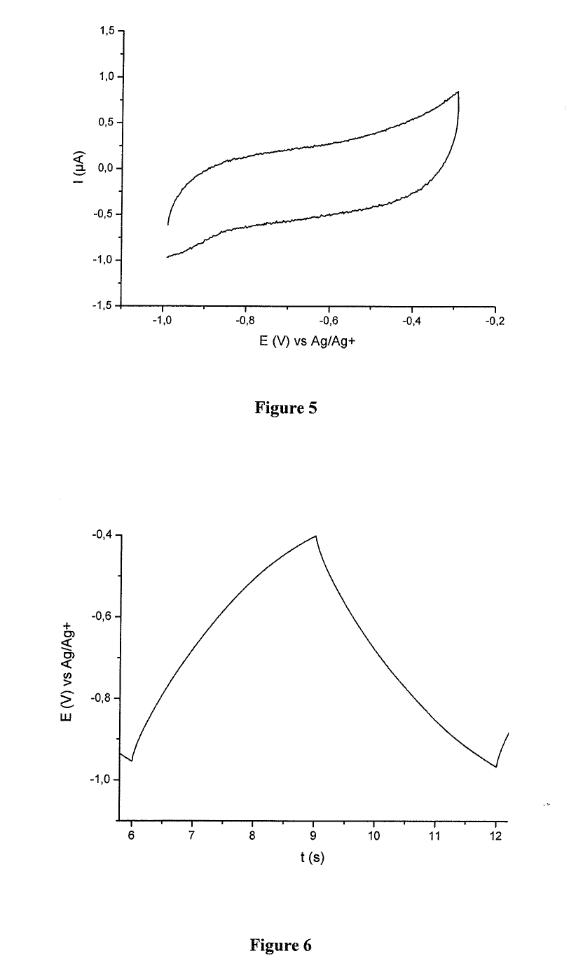

FIG. 5 shows the cyclic voltammetry curve between −1 V and −0.3 V vs Ag/Ag⁺ at 20 mV·s⁻¹ obtained with a device comprising a working electrode made of nanostructured p⁺⁺-doped silicon covered with a protective layer made of gold, in a free bath, using NEt₄BF₄, PC, 1M as the electrolyte and an Ag⁺/Ag electrode as a reference electrode and a counter electrode made of Pt; and

FIG. 6 shows the galvanostatic charge/discharge curve obtained with the same device as for FIG. 5.

The invention aims to provide electrodes, in particular for devices for storing and releasing energy, and more particularly for supercapacitors and/or pseudo-capacitive supercapacitors, the electrodes of which comprise a three-dimensional structure made of silicon, the nanostructures having a high area density.

Specifically, the performance of an electrochemical capacitor is directly proportional to its developed surface area and it is not possible with current electrodes to improve said performance beyond a certain limit.

Therefore, the invention proposes to use nanostructures, for example nanostructures made of silicon, the morphology and the nanostructuring of which allow the exchange area at the electrode/electrolyte interface to be very greatly increased.

To obtain a device having a capacitive behavior and to increase its stability over time, the invention proposes to deposit, on the nanostructures, a layer made of a dielectric and/or electroactive material that will perform the function of protecting the nanostructure.

Such a nanostructured electrode, when it is made of silicon, may be directly integrated into a microelectronic circuit.

Thus, the invention provides an electrode comprising a carrier, made of a conductor or semiconductor, comprising, on at least one of its surfaces, at least one nanostructure made of a semiconductor.

The conductor or semiconductor from which the carrier is made is preferably chosen from stainless steel, carbon, silicon, germanium, gallium arsenide (GaAs), alloys of silicon and germanium (SiGe) and indium phosphide (InP).

Preferably, the carrier is made of silicon.

The semiconductor nanostructures will preferably be made of a semiconductor chosen from silicon, germanium, gallium arsenide, alloys of silicon and germanium, and indium phosphide.

Preferably, the nanostructures are made of silicon.

These nanostructures may be obtained by catalyzed chemical vapor phase deposition growth.

They may also be obtained by etching.

When the carrier of the electrodes is made of silicon, the nanostructures will either be obtained by epitaxial growth or chemical vapor deposition (CVD), or by etching the structures directly into the silicon.

When the carrier of the electrodes is made of metal, the growth will be achieved only by CVD or crystal growth.

The invention is based on the surprising discovery that when a protective layer either made of a dielectric having an intrinsic capacitance comprised between 1.5×10⁻⁶ and 10×10⁻⁶ F/cm² or of a metal, and having a thickness of a few nanometers, is formed on the nanostructures, the electrode thus obtained exhibits, in the presence of an electrolyte, amazing capacitive responses for applications, in particular supercapacitors, involving organic, ionic liquid or ionogel electrolytes.

This protective layer must not have a thickness greater than the height of the nanostructures: it must not completely fill the interstructure space.

In other words, it must not planarize the surface of the electrode because otherwise the advantage of the structuring is lost.

Advantageously the layer is conformal, i.e. it closely follows the shape of the nanostructure. This layer is also uniform over the entire surface of the nanostructures. In other words, it must entirely cover the nanostructures and be, at each and every point on these nanostructures, sufficiently thick to protect them effectively.

This thickness depends on the density of the nanostructures.

In general, the thickness of the protective layer coating the nanostructures must not exceed 20 nm and must not be smaller than 2 nm. Preferably, the thickness of the protective layer will be larger than or equal to 3 nm.

This protective layer must also be sufficiently covering to protect the surface of the nanostructures, and in the case of a layer made of a dielectric, allow a high electrode capacitance to be preserved in the presence of an electrolyte.

The dielectrics preferred for forming this protective layer are the oxides and nitrides of transition elements, such as SiO₂, silicon nitride, “high-k” materials such as hafnium silicate, zirconium silicate, hafnium dioxide and zirconium dioxide.

In this case, the protective layer provides the nanostructure with passive protection.

However, the dielectric may also be ruthenium oxide (RuO₂), manganese dioxide (MnO₂), vanadium oxide (V₂O₅) or iron oxide (Fe₃O₄).

In this case, the protective layer actively protects the nanostructures: in addition to its role protecting the nanostructures the layer plays a role accumulating charge, which is added to the charge of the electrolyte.

When the dielectric is SiO₂ or silicon nitride or a high-k material, the capacitance per m² sought for the electrode is the highest possible with a continuous protective layer. Here we speak of the intrinsic capacitance of the material by itself.

In particular, in the case of SiO₂, a protective layer having a thickness smaller than 2 nm is not sufficiently protective and the capacitance per m² of the layer formed is only 1.73×10⁻⁶ F/cm². For this reason, preferably, the protective layer, in the case of SiO₂, must, preferably, be larger than or equal to 3 nm in thickness.

Therefore, in the case of SiO₂, the protective layer must be larger than 2 nm in thickness and smaller than 8 nm in thickness and more preferably comprised between 3 and 8 nm in thickness.

A layer having a thickness larger than or equal to 8 nm is too substantial with a capacitance per cm²=9.6×10⁻⁶ F/cm².

Thus, in the general case, the capacitance must be comprised between 1.73×10⁻⁶ and 9.6×10⁻⁶ F/cm² or more generally between 1.5×10⁻⁶ and 10×10⁻⁶ F/cm².

It may be deduced therefrom that in the case of silicon nitride, with an ∈=10, it will be necessary for the thickness of the layer to be comprised between 5 and 20 nm, and in the case of high-k materials with an ∈=1.6, it will be necessary for the thickness of the layer formed to be comprised between 3.2 nm and 12.8 nm.

Therefore, the protective layer must have, with these materials, a thickness comprised between 2 and 20 nm and preferably comprised between 5 and 20 nm.

This protective layer will possibly be formed by chemical or thermal oxidation.

For example, in the case of the formation of an SiO₂ protective layer on a silicon carrier, the chemical process consists in dipping the carrier/nanostructure assembly in a solution of an oxidizing acid such as sulfuric acid or nitric acid.

The oxidation reaction will be self-limited by the formation of the nanoscale thickness SiO₂ layer.

Again in the case of the formation of an SiO₂ protective layer on silicon nanostructures, the thermal process consists in carrying out a thermal anneal under an oxidizing atmosphere.

This technique is completely mastered in the microelectronics field.

It allows SiO₂ layers having a thickness of the order of a nanometer to be obtained.

Here, the layer formed closely follows the shape of the nanostructures (it is conformal) and completely covers the surface of the nanostructures with a sufficient thickness. In order to obtain a layer of SiO₂ having these properties, it is necessary to form it with one of the means described above. Specifically, a simple oxidation obtained by exposure to the oxygen in air, as in the case of the formation of native silicon oxide on nanostructures made of silicon, does not allow a continuous protective layer to be obtained having at every point a sufficient thickness to play the protective role of the protective layer according to the invention.

Lastly, the protective layer may be formed by chemical vapor deposition (CVD) of a dielectric other than SiO₂, for example RuO₂ or MnO₂.

Of course, the deposition must be a conformal deposition, i.e. the thickness of the layer formed must follow, very precisely, the contours of the nanostructures, in order to preserve the advantage of the nanostructuring.

However, the capacitive performance of this protective layer may be even further improved by covering this protective layer with an electroactive layer made of an intrinsically conductive polymer.

Conductive polymers are conductors that make it possible to enhance the current densities, and therefore the power and energy, of capacitors and to add a volumetric capacitance to the protective layer.

Appropriate conductive polymers will be clearly apparent to those skilled in the art, but they are preferably chosen from poly(3,4-ethylenedioxythiophene)s, poly(2,7-carbazole)s, poly(3,6-carbazole)s, polyanilines and polypyrroles.

This intrinsically conductive polymer layer may be deposited on the formed protective layer by an electrochemical process (for example by electropolymerization) or by sublimation or by evaporation or by conventional deposition (spin coating, resist deposition, etc.).

The thickness of this protective layer may be controlled by measuring synthesis charge, for example by coulometry.

This thickness will be adjusted in order to preserve the nanostructuring of the wires making up the nanostructures.

Thus, the total thickness of the protective layer and of the conductive polymer layer must not cause the nanostructuring due to the nanostructures to disappear, and the total thickness of these two layers must not be equal to or exceed the height of the nanostructures.

The electrode of the invention may be used in a device for storing and releasing electrical energy.

Such a storage device generally comprises at least two electrodes.

Thus, only one of these electrodes may be an electrode according to the invention.

However, at least two of these electrodes may both be, advantageously identical, electrodes according to the invention.

When only one of these electrodes is an electrode according to the invention, the other electrode is made of carbon and has a high specific surface area.

In one preferred embodiment, when the electrode is an electrode according to the invention, it is an electrode the carrier of which is made of silicon, the nanostructure then being grown on this carrier and itself being made of silicon.

The protective layer covering the nanostructure is then preferably a silica (SiO₂) layer obtained by oxidizing the silicon surface.

In one even more preferred embodiment, this electrode, the carrier and nanostructures of which are made of silicon and coated with a layer of silicon oxide, in addition comprises a layer made of a conductive polymer, namely poly(3,4-ethylenedioxythiophene).

The electrodes according to invention are fabricated by a process that is also a subject of the invention.

This process comprises a step of forming, on at least one semiconductor nanostructure formed on a carrier made of a semiconductor or conductor, a protective layer made of a material chosen from a dielectric having an intrinsic capacitance comprised between 1.5×10⁻⁶ and 10×10⁻⁶ F/cm² and a metal, this layer having a thickness smaller than the height of the nanostructure.

The height of the nanostructure corresponds to the distance between the surface of the carrier and the surface of the nanostructure, when considered in one and the same plane.

The carrier of the electrodes is preferably made of a conductor or semiconductor chosen from stainless steel, carbon, silicon, germanium, gallium arsenide, alloys of silicon and germanium, and indium phosphide.

More preferably, the carrier is made of silicon.

As for the nanostructure, it is preferably made of a semiconductor chosen from silicon, germanium, gallium arsenide, alloys of silicon and germanium, and indium phosphide.

More preferably, it is made of silicon.

The term “nanostructure” is understood to mean a wire, a nanowire, a nanotree, etc.

Such a nanostructure must have an aspect ratio higher than 5, advantageously higher than 20 and more advantageously higher than 100. This aspect ratio applies to the wires and to the branches and trunks of trees.

When the protective layer covering the structure is made of a dielectric, this dielectric is preferably chosen from silica, hafnium silicate, zirconium silicate, hafnium dioxide, zirconium dioxide, silicon nitride, ruthenium dioxide (RuO₂), manganese dioxide (MnO₂), vanadium oxide (V₂O₅) and iron oxide (Fe₃O₄).

Hafnium silicate, zirconium silicate, hafnium dioxide and zirconium dioxide are what are referred to as “high-k” materials.

Preferably, this layer is a silica layer, in particular when the nanostructure and/or the carrier are made of silicon.

Specifically, in this case, the dielectric layer may be formed by a simple oxidation of the surface of the nanostructure and/or of the carrier.

However, the layer referred to as the protective and nanostructuring layer of the nanostructure may also be made of metal.

In this case, preferably, the metal is chosen from gold (Au), platinum (Pt), silver (Ag), nickel (Ni) and titanium (Ti) and the thickness of this layer must be comprised between 2 and 20 nm inclusive, preferably between 3 and 20 nm and more preferably between 3 and 8 nm inclusive, in order to form a sufficiently protective layer while preserving a good capacitance.

In one preferred embodiment, the electrode fabrication process according to the invention in addition comprises a step of depositing a layer made of an intrinsically conductive polymer on the protective layer made of a dielectric or of metal.

Preferably, this layer made of an intrinsically conductive polymer is a layer made of a polymer chosen from poly(3,4-ethylenedioxythiophene)s, poly(2,7-carbazole)s, poly(3,6-carbazole)s, polyanilines and polypyrroles.

More preferably, this layer is made of poly(3,4-ethylenedioxythiophene).

When two layers are formed on the nanostructures, these two layers together must not planarize the surface of the electrode.

For this reason, the thickness of these two layers must be smaller than the height of the nanostructure. Furthermore, independently of whether a single layer or two layers is/are deposited on the nanostructures, the layer/layers must be deposited conformally on the nanostructure, i.e. the layers must follow the shape of the nanostructure closely.

In order to allow the invention to be better understood, embodiments thereof will now be described by way of nonlimiting and purely illustrative example.

### EXAMPLE 1

On a carrier made of silicon, a metal catalyst, here gold, was deposited.

This metal was the site of the growth of the 3D silicon nanostructures.

The catalyst was formed by dewetting a thin film of the metal by heating, this causing nanodroplets to form.

However, the catalyst may also be formed by depositing colloids of the metal catalyst.

The second step was then the formation of the nanostructures from the deposited metal.

In this example, the nanostructures were made of silicon and were obtained by chemical vapor deposition using silane.

However, disilane may also be used.

To dope these nanostructures during their growth, compounds based on boron, phosphorus or arsenic were added to the silane gas flow depending on the desired doping.

Branched structures (nanotrees) were obtained using catalysts found on the main trunk.

These catalysts may originate:

i) from migration of the main catalyst during the growth of the trunk (in this case, the growth is carried out in one or two steps); or

ii) from a new catalyst deposition, after the trunk has been grown.

The silicon nanostructures will form one or two electrodes depending on the final component. Thus, if the final component must have a low price, only a single electrode will be formed; however, to obtain a high performance two electrodes according to the invention will be used.

The third step was the step of creating the protective layer of the nanostructures.

In this example, the nanostructures being made of silicon, chemical oxidation was the simplest solution to use to obtain a silica layer on the nanostructures.

However, when it is desired to obtain a protective layer made of another metal oxide, said layer will be deposited on the surface of the silicon nanostructures using a dynamic electrochemical method such as cyclic voltammetry or chronopotentiometry.

This protective layer may also be deposited by sublimation or evaporation.

In this example, the height of the nanostructures was 10 μm, which corresponded to their length, and the protective layer had a thickness of 3 nm.

### Characterization of the Electrode of Example 1

A device was fabricated with two identical electrodes according to example 1, of 1 cm² area, on a silicon carrier, one being based on a network of nanowires made of p⁺⁺-doped silicon, i.e. highly p-doped silicon (large electron deficit and therefore excess holes, considered to be positively charged, in this case doped with 4×10¹⁹ boron atoms/cm³), and the other on a network of nanowires made of n⁺⁺-doped silicon, i.e. highly n-doped silicon (excess of electrons, considered to be negatively charged, in this case doped with 4×10¹⁹ phosphorus atoms/cm³), each having a density of 5×10⁸ nanowires/cm².

The nanowires had a diameter of 100 nm and were coated with a protective layer of SiO₂ having a thickness of 3 nm.

The device in addition comprised:
an organic electrolyte that was a solution of tetraethylammonium tetrafluoroborate in propylene carbonate in a concentration of 1 mol·L⁻¹ (NEt₄BF₄, PC, 1M);
a separator made of Celgard®; and
collectors made of aluminum,

all of the above being maintained between two Teflon isolators.

This device was tested by galvanostatic charge/discharge cycling.

The cycling was carried out at plus or minus 5 μA/cm² between 0.01 V and 1 V.

FIG. 1 shows the variation of the potential in volts as a function of the cycling time for the device of example 1. As may be seen in FIG. 1, the cyclic behavior was almost ideal and characteristic of that of a supercapacitor.

The variation in the capacitance per unit area of the device was also determined.

The variation of this capacitance in μF/cm² as a function of the number of cycles is shown in FIG. 2.

As may be seen in FIG. 2, the capacitance per unit area was stable under cycling.

### EXAMPLE 2

In another embodiment, the electrode of example 1 was in addition covered with a layer made of an intrinsically conductive polymer that here was poly(3,4-ethylenedioxythiophene).

A layer made of poly(2,7-carbazole)s or of poly(3,6-carbazole)s or of polyanilines could also have been deposited in the same way.

This layer was deposited in this example by voltammetry.

It may also be deposited by chronopotentiometry, or by vaporization and evaporation when the conductive polymer is soluble in a solvent.

The capacitance of the capacitor was then increased by a factor of 100 without degrading stability.

### EXAMPLE 3

A so-called “free bath” device (i.e. a device without a separator and in a large volume of electrolyte, here about 5 mL) was fabricated with the same electrode of example 1, the electrolyte being 1-ethyl-3-methylimidazolium bis(trifluoromethylsulfonyl)imide (EMI-TFSI), which is an ionic liquid.

The electrode according to the invention had an area of 0.2 cm², the counter electrode was made of platinum and the reference electrode of Ag/Ag′.

### COMPARATIVE EXAMPLE

The same device as in example 3 was fabricated, but the network of silicon nanowires was not oxidized, as in the prior art.

### Results

The devices of example 3 and of the comparative example were tested by cyclic voltammetry at 2 mV·s⁻¹ using a Ag⁺/Ag reference electrode.

The cyclic voltammetry curves obtained are shown in FIG. 3.

In FIG. 3, the curve referenced “invention” is the curve obtained with the device of example 3, and the curve referenced “prior art” is the cyclic voltammetry curve obtained with the device of the comparative example.

As may be seen in FIG. 3, the cyclic voltammetry curve of the device of example 3 was similar to that of a supercapacitor (horizontal curve) whereas the cyclic voltammetry curve of the device of the comparative example was not.

For the device of example 3, the variation over time of the cyclic voltammetry curves at 20 mV·s⁻¹ was also examined.

The curves obtained are shown in FIG. 4, in which the curve referenced (1) is the initial cyclic voltammetry curve and the curve referenced (2) is the cyclic voltammetry curve obtained after 2 hours of cycling.

The stability of the electrodes of this device was maintained, as demonstrated by the curves which are horizontal and very close to each other: there was no loss of capacitance.

### EXAMPLE 4

An electrode according to the invention was fabricated with a protective layer made of gold.

To do this, silicon nanowires were grown on a substrate made of n⁺⁺-doped silicon, by CVD (chemical vapor deposition), using silane.

The catalyst used was 50 nm-diameter gold colloids.

Silicon nanowires having a diameter of about 50 nm, a length of about 5 μm and a density of about 5×10⁸ nanowires/cm² were obtained, the nanowires being doped n⁺⁺.

The silicon nanowires forming the nanostructures were covered with a protective gold layer having a thickness of 8 nm by evaporation of gold.

The electrode obtained was used in an electrochemical test setup comprising 3 electrodes: a working electrode (namely the electrode obtained above), an Ag⁺/Ag reference electrode and a platinum (Pt) counter electrode.

The electrode used was a solution of NEt₄BF₄, PC, 1M, as in example 1.

This device was tested by cyclic voltammetry between −1 V and −0.3 V vs Ag⁺/Ag at 20 mV·s⁻¹.

The curve obtained is shown in FIG. 5.

As may be seen in FIG. 5, the curve obtained was very close to that of a supercapacitor.

This device was also tested by galvanostatic charge and discharge cycling.

The cycling was carried out at ±8 μA·cm⁻² between −0.97 V and −0.4 V vs Ag⁺/Ag.

The curve obtained is shown in FIG. 6.

As may be seen in FIG. 6, this curve was close to that obtained with a supercapacitor.

The capacitance per unit area of this device was calculated from these two curves: the average capacitance per unit area is 45 μF·cm⁻², which is larger than the average capacitance per unit area of the same device when the protective layer is a layer of silicon oxide, this capacitance then being 26 μF·cm⁻².

The device of this example may therefore store more energy than the device in which the protective layer is a layer of silicon oxide because the energy stored by a device is proportional to its average capacitance per unit area.

A device identical to that of example 4 but not comprising a protective layer did not exhibit a capacitive behavior.

1. An electrode comprising a carrier, made of a conductor or semiconductor, this carrier comprising, on at least one of its surfaces, at least one nanostructure made of a semiconductor, wherein the electrode in addition comprises a conformal protective layer made of a material chosen from a dielectric having an intrinsic capacitance comprised between 1.5×10⁻⁶ and 10×10⁻⁶ F/cm² and a metal, said protective layer having a thickness smaller than the height of said nanostructure, and covering the at least one nanostructure.

2. The electrode as claimed in claim 1, wherein the carrier is made of a conductor or semiconductor chosen from stainless steel, carbon, silicon, germanium, gallium arsenide (GaAs), alloys of silicon and germanium in any proportions (SiGe) and indium phosphide (InP).

3. The electrode as claimed in claim 1, wherein the nanostructure is made of a semiconductor chosen from silicon, germanium, gallium arsenide, alloys of silicon and germanium in any proportions and indium phosphide.

4. The electrode as claimed in claim 1, wherein the protective layer is made of a dielectric chosen from SiO₂, hafnium silicate, zirconium silicate, hafnium dioxide, zirconium dioxide, silicon nitride, ruthenium dioxide (RuO₂), manganese dioxide (MnO₂), vanadium oxide (V₂O₅) and iron oxide (Fe₃O₄).

5. The electrode as claimed in claim 1, wherein said protective layer is made of metal chosen from gold (Au), platinum (Pt), silver (Ag), nickel (Ni) and titanium (Ti) and the thickness of this layer is comprised between 2 and 20 nm inclusive.

6. The electrode as claimed in claim 1, wherein the electrode in addition comprises a layer made of an intrinsically conductive polymer, on the protective layer made of a dielectric or of metal, this layer made of an intrinsically conductive polymer and the protective layer made of a dielectric or of metal having a total thickness smaller than the height of the nanostructure.

7. The electrode as claimed in claim 6, wherein the intrinsically conductive polymer is chosen from poly(3,4-ethylenedioxythiophene)s, poly(2,7-carbazole)s, poly(3,6-carbazole)s, polyanilines and polypyrroles.

8. A device for storing and releasing electrical energy, wherein the device comprises at least one electrode as claimed in claim 1.

9. The device as claimed in claim 8, wherein the device comprises at least two identical electrodes as claimed in claim 1.

10. The device as claimed in claim 8, wherein the device comprises at least two electrodes one of which is an electrode comprising a carrier, made of a conductor or semiconductor, this carrier comprising, on at least one of its surfaces, at least one nanostructure made of a semiconductor, wherein the electrode in addition comprises a conformal protective layer made of a material chosen from a dielectric having an intrinsic capacitance comprised between 1.5×10⁻⁶ and 10×10⁻⁶ F/cm² and a metal, this conformal protective layer having a thickness smaller than the height of said nanostructure, and covering the at least one nanostructure, and the other of which is made of carbon, with a specific surface area larger than 1500 m²/g.

11. A process for fabricating an electrode comprising a carrier made of a conductor or semiconductor, this carrier comprising, on at least one of its surfaces, at least one nanostructure made of a semiconductor, wherein the method comprises a step of forming, on said nanostructure, a protective layer made of a material chosen from a dielectric having a capacitance comprised between 1.5×10⁻⁶ and 10×10⁻⁶ F/cm² and a metal, this layer having a thickness smaller than the height of said nanostructure.

12. The process as claimed in claim 11, wherein the process in addition comprises a step of fabricating the nanostructure by chemical vapor deposition (CVD).

13. The process as claimed in claim 11, wherein the protective layer is formed by chemical or thermal oxidation of the surface not making contact with the carrier of the nanostructure.

14. The process as claimed in claim 11, wherein the protective layer is formed by nitriding the surface not making contact with the carrier of the nanostructure.

15. The process as claimed in claim 11, wherein the process in addition comprises a step of depositing a layer made of a conductive polymer, on the protective layer made of a dielectric or of metal, this layer made of an intrinsically conductive polymer and the layer made of a dielectric or of metal having a total thickness smaller than the height of the nanostructure.

16. The electrode as claimed in claim 1, wherein the carrier is made of a conductor or semiconductor comprising silicon.

17. The electrode as claimed in claim 1, wherein the nanostructure is made of a semiconductor comprising silicon.

18. The electrode as claimed in claim 1, wherein the protective layer is made of a dielectric comprising SiO₂.

19. The electrode as claimed in claim 5, wherein said protective layer has a thickness selected from the group consisting of between 3 and 20 nm inclusive and between 3 and 8 nm inclusive.

20. The electrode as claimed in claim 6, wherein said layer made of an intrinsically conductive polymer has a total thickness selected from the group consisting of between 2 and 20 nm, between 3 and 20 nm, and between 3 and 8 nm.
